(19) United States
(12) Patent Application Publication
(10) Pub. No.: US 2026/0078664 A1
(43) Pub. Date: Mar. 19, 2026

(54) TRANSMISSION TOMOGRAPHY FOR STRUCTURE AND MINEROLOGY OF SOLIDS

(71) Applicant: Schlumberger Technology Corporation, Sugar Land, TX (US)

(72) Inventor: Can Evren Yarman, Paris (FR)

(21) Appl. No.: 18/884,265

(22) Filed: Sep. 13, 2024

(51) Int. Cl. E21B 47/002; E21B 47/09; G01V 5/08

(52) U.S. Cl. CPC E21B 47/0025; E21B 47/09; G01V 5/08

(57) ABSTRACT

A system is provided that includes one or more sources used to irradiate one or more solids extracted from a reservoir with an energy source and one or more detectors used to acquire one or more transmission images, wherein the one or more transmission images comprise one or more scans. The system also includes a processing circuitry and a memory, accessible by the processing circuitry, the memory storing instructions that, when executed by the processing circuitry cause the processing circuitry to perform operations. The operations may include collecting one or more scans of the one or more solids moving through an imaging zone, reconstructing one or more tomographic images of the one or more solids based on the one or more scans, and extracting one or more physical properties of the solids based on the one or more tomographic images.

### BACKGROUND

The present disclosure generally relates to systems and methods for measuring structural properties of solids extracted from geological reservoirs. More specifically, the present disclosure is directed to forming a digital representation of a geological reservoir based on image analysis of moving solids.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Characterization of environments via analysis of solids (e.g., rock particles) has been widely used in industry and scientific applications, including, but not limited to, space exploration, mining, civil engineering, geothermal, and oil and gas. Image data of the solids typically come from imaging systems that produce digital images or three-dimensional (3D) images from a laser scanner. Once solids are detected and segmented, they may be used to compute the properties such as size, shapes, textures, morphology, structure, petrophysical properties, and the like.

In oil and gas, geothermal, as well as scientific exploration applications, solids are produced during drilling activities. The solids are called cuttings or carvings, depending on their sizes. Solids are generally used to identify lithology types for use in subsurface characterization and are one of the highest available and lowest cost data sources for understanding and characterizing the subsurface properties. As such, there is a need to characterize solids early in the drilling process to provide accurate and near real-time reconstruction of the subsurface properties (e.g., reservoir characteristics).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system is provided that includes one or more sources used to irradiate one or more solids extracted from a reservoir with an energy source and one or more detectors used to acquire one or more transmission images, wherein the one or more transmission images comprise one or more scans. The system also includes a processing circuitry and a memory, accessible by the processing circuitry, the memory storing instructions that, when executed by the processing circuitry cause the processing circuitry to perform operations. The operations may include collecting one or more scans of the one or more solids moving through an imaging zone, reconstructing one or more tomographic images of the one or more solids based on the one or more scans, and extracting one or more physical properties of the solids based on the one or more tomographic images.

In certain embodiments, a method includes extracting one or more solids from a reservoir, moving the one or more solids through an imaging zone, wherein the imaging zone comprises one or more sources and one or more detectors, collecting one or more scans of the one or more solids moving through the imaging zone, and reconstructing one or more tomographic images of the one or more solids based on the one or more scans; and extracting one or more physical properties of the solids based on the one or more tomographic images.

In certain embodiments, a non-transitory, computer-readable storage medium, comprising processor-executable routines that, when executed by a processor, cause the processor to perform operations including extracting one or more solids from a reservoir, moving the one or more solids through an imaging zone, wherein the imaging zone comprises one or more sources and one or more detectors, collecting one or more scans of the one or more solids moving through the imaging zone, and reconstructing one or more tomographic images of the one or more solids based on the one or more scans; and extracting one or more physical properties of the solids based on the one or more tomographic images. The operations also include forming a digital representation of the reservoir based on the one or more physical properties of the one or more solids and controlling a drilling system based on the digital representation of the reservoir.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating a drilling system including an imaging system and an analysis system, in accordance with an embodiment of the present disclosure;

FIG. 2 is a schematic diagram illustrating a shale shaker removing solids from drilling fluid including the analysis system of FIG. 1, in accordance with an embodiment of the present disclosure;

FIG. 3 is a schematic embodiment of a drill bit generating solids, in accordance with aspects of the present disclosure;

FIG. 4 is a schematic diagram illustrating a drilling system including the analysis system, one or more detectors, and one or more sources, in accordance with an embodiment of the present disclosure;

FIG. 5 is cross-sectional view of the analysis system, the one or more detectors, and the one or more sources of FIG. 4, in accordance with an embodiment of the present disclosure;

FIG. 6 is a flow chart of a process for extracting one or more physical properties from image data of solids extracted from a reservoir, in accordance with an embodiment of the present disclosure; and

FIG. 7 is a schematic embodiment of an electronic display screen displaying a graphical user interface (GUI) generated by the analysis system, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, whenever a drilling process is involved in an activity, solids (e.g., rock cuttings) are produced and are generally available at the well site. Traditionally, solids are removed from the well site and, after going through a manual sample preparation process, characterized off-site using image analysis techniques to characterize solids to provide information related to geological subsurfaces associated with the well site. Removal of solids from the well site and sample preparation process generally prevent near real-time reconstruction of the subsurface properties (e.g., reservoir characteristics). As such, characteristics of solids are generally under-utilized for the subsurface characterization by geoscientists and reservoir engineers in the oil and gas industry. As such, a need exists for achieving near real-time analysis of structural properties of solids.

Accordingly, the present disclosure techniques may be used to acquire near real-time structural information of solids at a well-site. A tomography system is described herein that enables collection, interpretation, and reconstruction of structural properties of solids. The tomography system may include an imaging system and an analysis system to provide structural information of solids for use in identifying lithology types for use in subsurface characterization. In some embodiments, the imaging system may include sources and detectors to enable transmission tomography of solids extracted from a wellbore in near real-time. In some embodiments, the imaging system may form hyperspectral images through collection of transmission signals of solids at multiple energy levels. Such transmission tomography may be used to collect data associated with the solids in a non-destructive fashion. The hyperspectral images may be analyzed by the analysis system to provide structural data associated with the solids. The structural data may be interpreted to provide a digital representation of the reservoir and/or the geological formation and subsurface as a whole. As such, embodiments of the present disclosure relate to near real-time acquisition of spectral data of solids being extracted from a reservoir. In certain embodiments, the solids may be moving during spectral acquisition. For example, the solids may be moving along a conveyor belt of a shale shaker, falling from the conveyor belt, and the like. As such, embodiments herein are directed to implementation of the analysis system to identify, track, and characterize each moving solid of the solids being extracted from the reservoir. It should be noted, although described herein as systems and methods for analyzing images of solids, it will be appreciated that the embodiments described herein may be capable of analyzing images of various types of solids, such as cuttings, cavings, and so forth as well as non-rock objects in the mud, such as mud additives, metal shavings, and foreign objects.

In some embodiments, the analysis system may detect structural information that may be found in geological formations. For example, spectroscopic signatures obtained by the imaging system may be analyzed and associated with particular minerals found in the solids. That is, reconstruction of structural properties of the solids may provide insight of a structure of the geological formations. As described herein, near real-time acquisition of the structural properties of the solids may provide near real-time understandings of the geological formations. These understandings may be provided in seismic data images, which may be used to identify hydrocarbon deposits, map geological formations, and the like to expedite and improve hydrocarbon exploration and production operations. For example, the near real-time acquisition of the structural properties of the solids may be used by a control system of a drilling system to alter one or more aspects of a drilling operation, such changing a direction of drilling via a rotary steerable system (RSS), changing a speed of rotation of a drill bit, changing a flow rate of a drilling mud, controlling a pressure of the well, or any combination thereof.

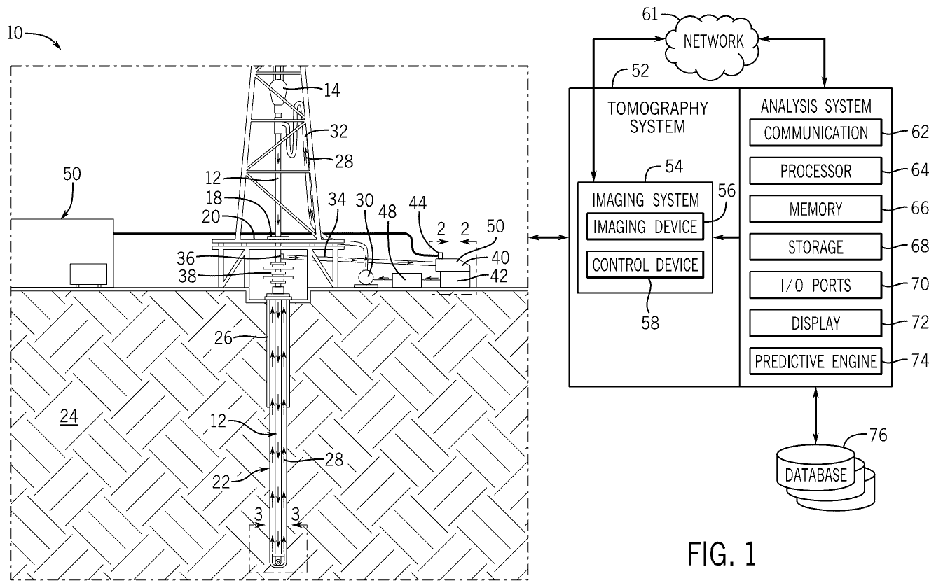

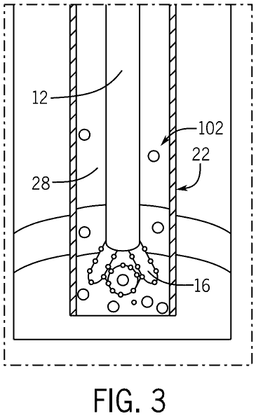

With this in mind, FIG. 1 is a schematic diagram illustrating a drilling system 10 in accordance with the embodiments described herein. As illustrated, in certain embodiments, a drill string 12 may be suspended at an upper end by a kelly and a traveling block 14 and terminated at a lower end by a drill bit 16 (shown in FIG. 3). The drill string 12 and the drill bit 16 are rotated by a rotary table 18 on a driller floor 20, thereby drilling a borehole 22 into earth formation 24, where a portion of the borehole 22 may be cased by a casing 26. As illustrated, in certain embodiments, drilling fluid or drilling “mud” 28 may be pumped by a mud pump 30 into the upper end of the hollow drill string 12 through a connecting mud line 32. From there, the drilling fluid 28 may be pumped downward through the drill string 12, exiting the drill string 12 through opening in the drill bit 16, and returning to the surface by way of an annulus formed between the wall of the borehole 22 and an outer diameter of the drill string 12. Once at the surface, the drilling fluid 28 may return through a return flow line 34, for example, via a bell nipple 36. As illustrated, in certain embodiments, a blowout preventer 38 may be used to prevent blowouts from occurring in the drilling system 10.

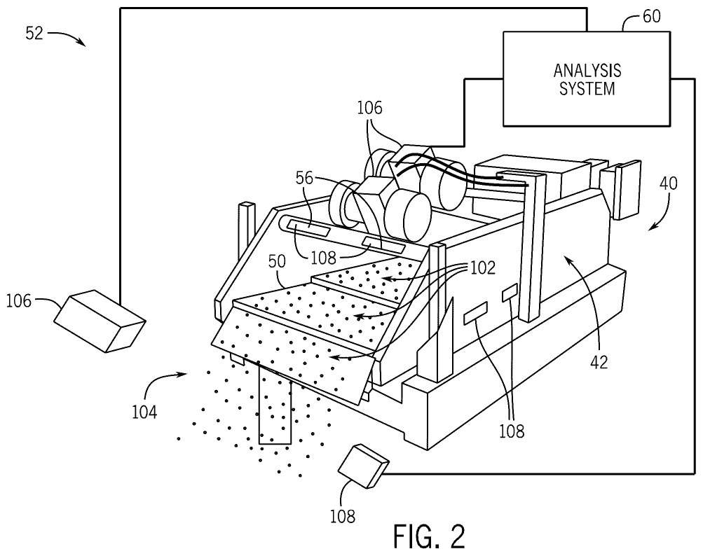

As illustrated in FIG. 1, solids that are formed by the drill bit 16 crushing rocks in the earth formation 24 may typically be removed from the returned drilling fluid 28 by a shale shaker 40 in the return flow line 34 such that the drilling fluid 28 may be reused for injection, where the shale shaker 40 includes a shaker pit 42 and a gas trap 44. The drilling fluid 28 may then be delivered to a mud pit 48 from which the mud pump 30 may draw the drilling fluid 28. The shale shaker 40 may include a conveyor 50, which may be used to transfer the solids for reinjection into the borehole 22. In some embodiments, the drilling system 10 may include a tomography system 52. The tomography system 52 may include all equipment associated with acquiring, preparing, imaging, and analyzing the solids. For example, the tomography system 52 may include an imaging system 54 and an analysis system 60. The imaging system 54 may include an imaging device 56 to take images of the solids. The imaging device 56 may include one or more sources, one or more detectors, or a combination thereof. The sources and detectors may be used for transmission tomography as described further in reference to FIGS. 2, 4, and 5. Spectral data obtained by the imaging device 56 may include hyperspectral images, images, optical signals, and the like. In some embodiments, the imaging device 56 may be any type of optical, transmission, or electronic microscope, camera, and the like. In some instances, the images obtained by the imaging device 56 may be digital images acquired by a camera. The camera may include an infrared camera, a CCD camera, a DSLR camera, a SLR camera, a mirrorless camera, or one or more digital cameras. The spectral data may be analyzed as discussed in further detail below.

The imaging system 54 may also include a control device 58 (e.g., processor-based controller) to control the imaging device 56 and operational conditions (e.g., lighting, temperature, moisture) associated with data acquisition by the imaging system 54. For example, the control device 58 may adjust the parameters (e.g., source intensity, exposure, focus, resolution,, and the like) of the imaging device 56. The imaging system 54 may be located at an oil and gas work site positioned to capture spectral data of the solids moving on the conveyor 50, falling from the conveyor 50, and/or additional suitable configurations. The control device 58 may be located at the oil and gas work cite or at one or more remote locations. Further, the control device 58 may be communicatively coupled to the analysis system 60 to provide spectral data for further analysis, reconstruction, and output.

The analysis system 60 may be used to receive and analyze spectral data (e.g., hyperspectral images) from the imaging system 54 directly or via a network 61. The analysis system 60 may be located at the oil and gas work site or at one or more remote locations. The analysis system 60 may include a communication component 62, a processor 64, a memory 66, a data storage 68, input/output (I/O) ports 70, a display 72, a predictive engine 74, and the like. The network 61 may include transceivers, receivers, and/or transmitters to facilitate data communication to and/or from the analysis system 60. For example, spectral data from the imaging system 54 may be transmitted to the analysis system 60 through the network 61. Further, external data (e.g., data about a geologic formation) may be gathered from a remote system and transmitted to the analysis system 60 via the network 61. However, in some embodiments, data may be transmitted directly from the devices (e.g., the imaging system 54) to the analysis system 60. Indeed, the analysis system 60 may communicate with the devices directly and/or through the network 61 in accordance with present embodiments. In certain embodiments, the spectral data may be automatically communicated from the imaging system 54 to the analysis system 60 for analysis in real-time, thereby enabling real-time responses (e.g., adjusting the imaging system 54, retaking images that are unacceptable, controlling and adjusting the drilling system 10, etc.) to information obtained from analysis of the data.

The communication component 62 may be a wireless or wired communication component (e.g., circuitry) that may facilitate communication between the analysis system 60, various types of devices, the network 61, and the like. Additionally, the communication component 62 may facilitate data transfer to the analysis system 60, such that the analysis system 60 may receive data from the other components depicted in FIG. 1 and the like. The communication component 62 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 64 may include single-threaded processor(s), multi-threaded processor(s), or both. The processor 64 may process instructions stored in the memory 66. The processor 64 may also include hardware-based processor(s) each including one or more cores. The processor 64 may include general purpose processor(s), special purpose processor(s), or both. The processor 64 may be communicatively coupled to other internal components (such as the communication component 62, the data storage 68, the I/O ports 70, and the display 72).

The memory 66 and the data storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. As used herein, applications may include any suitable computer software or program that may be installed onto the analysis system 60 and executed by the processor 64. The memory 66 and the data storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. The display 72 may operate as a human machine interface (HMI) to depict visualizations associated with software or executable code being processed by the processor 64. The display 72 may display a map of the geological formation data (e.g., images and information derived from the images) corresponding to positions on the map, alerts/alarms when image data is not acceptable, recommendations associated with the alerts/alarms, etc. In one embodiment, the display 72 may be a touch display capable of receiving inputs from an operator of the analysis system 60. The display 72 may be any suitable type of display, such as a liquid crystal display (LCD), plasma display, or an organic light emitting diode (OLED) display, for example. Additionally, in one embodiment, the display 72 may be provided in conjunction with a touch-sensitive mechanism (e.g., a touch screen) that may function as part of a control interface for the analysis system 60.

The predictive engine 74 may use various machine learning algorithms to analyze images obtained for the solids to identify lithology of the rock samples. The predictive engine 74 may utilize one or more predictive models for analysis of the variety of data received by the analysis system 60. Various types of predictive models may be used to analyze data from variety of resources and generate predictive outputs. For example, the predictive engine 74 may be trained with supervised machine learning technique, i.e., a predictive model is trained with training data that includes input data and desired predictive output (e.g., labeled dataset). The predictive engine 74 may also be trained with unsupervised machine learning technique, i.e., a predictive model is trained with training data that includes input data but without desired predictive output (e.g., unlabeled dataset). The predictive engine 74 may include various types of artificial neural networks (ANN), such as Convolution Neural Networks (CNN), Recurrent Neural Networks (RNN), etc. The analysis system 60 may also communicate with one or more database 76, which may store information associated with the drilling system 10, related external resources (e.g., geologic formation history), etc.

It should be noted that the components described above with regard to the tomography system 52 are exemplary components and the tomography system 52 may include additional or fewer components as shown. In addition, although the components are described as being part of the analysis system 60, the components may also be part of any suitable computing device described herein such as the shale shaker 40, the conveyor 50, the imaging device 56, the control device 58, and the analysis system 60, and the like to perform the various operations described herein.

FIG. 2 is a schematic diagram illustrating an embodiment of the tomography system 52. The tomography system 52 may be coupled to the shale shaker 40. The shale shaker 40 may be used to remove one or more solids 102 from drilling fluid. The shale shaker 40 may include the conveyor 50. The conveyor 50 may move the solids 102 through the shale shaker 40 to an outlet 104. As shown, the imaging system 54 and the analysis system 60 as described in FIG. 1 may be positioned proximate to the shale shaker 40. As such, the tomography system 52 may generate and process spectral data of the solids 102 removed from the drilling fluid 28 in the shaker pit 42 of the shale shaker 40. With this in mind, FIG. 3 is a schematic embodiment of a drill bit 16 generating solids 102. As shown, the drill bit 16 generates the solids 102 that may flow back up within the drilling fluid 28 through an annulus formed between the wall of the borehole 22 and an outer diameter of the drill string 12. As such, the solids 102 may be used to assess structural information related to the borehole 22. In this manner, understanding of structural information of the solids 102 may provide insight to the reservoir being drilled. For example, as the drill bit 16 breaks through layers of sediment, structural information surrounding the borehole 22 may vary with depth. As such, it may be advantageous to analyze the solids 102 in near real-time to provide data associated with the reservoir to inform drilling operations, such that a control system can adjust one or more operational parameters of the drilling system 10 in near real-time based on the analysis of the solids 102. In this manner, as the solids 102 flow up within the drilling fluid 28 the tomography system 52 may be used to image and analyze the solids 102 in near real-time.

Returning now to FIG. 2, in some embodiments, the tomography system 52 may include one or more imaging devices 56. The imaging devices may include one or more sources 106 and one or more detectors 108 to capture spectral data of the solids 102. The sources 106 may include one or more X-ray sources, one or more gamma ray sources, one or more positron sources, and/or additional suitable energy sources. The detectors 108 may be configured to include one or more detector arrays, one or more long detector, multiple small detectors, a pushbroom detector (e.g., configured to generate a hyperspectral data cube of spatial and spectral information), a point detector, one or more cameras, and the like. The detectors 108 may include one or more xenon gas detectors, one or more solid state detectors, one or more scintillators, one or more a thermal imager, a complementary metal-oxide-semiconductor (CMOS) camera, a charge-coupled device (CCD), electron-multiplier charge-coupled device (EMCCD), one or more photodiodes, pyroelectric sensors, one or more photodetectors, a photomultiplier tube (PMT), and/or other suitable detectors. It should be noted, in some embodiments, the sources 106 and the detectors 108 may be housed in a single housing. For example, a camera may be used as both a source and a detector to capture image data of the solids 102.

In some embodiments, the imaging devices 56 (e.g., the sources 106, the detectors 108) may be controlled by one or more control devices 58. The control devices 58 may control a position of the imaging devices 56. For example, the sources 106 may be fixed or movable in relation to the shale shaker 40. As shown, the sources 106 may be positioned to image the solids 102 moving on the conveyor 50, falling out the outlet 104 of the shale shaker 40, or a combination thereof. Further, in some embodiments the detectors 108 may be positioned opposite of the sources 106. In this manner, the sources 106 may collect signals generated as a result of transmission of energy from the source 106 through the solids 102. In some embodiments, the detectors 108 may be positioned at one or more angles from the sources 106, the solids 102, the shale shaker 40, and the like to collect signals as a result of source interaction with the solids 102 (e.g., energy source/matter interaction). As shown, the sources 106 and the detectors 108 may be positioned to capture signals (e.g., transmission signals) as the solids 102 fall from the outlet 104 of the shale shaker.

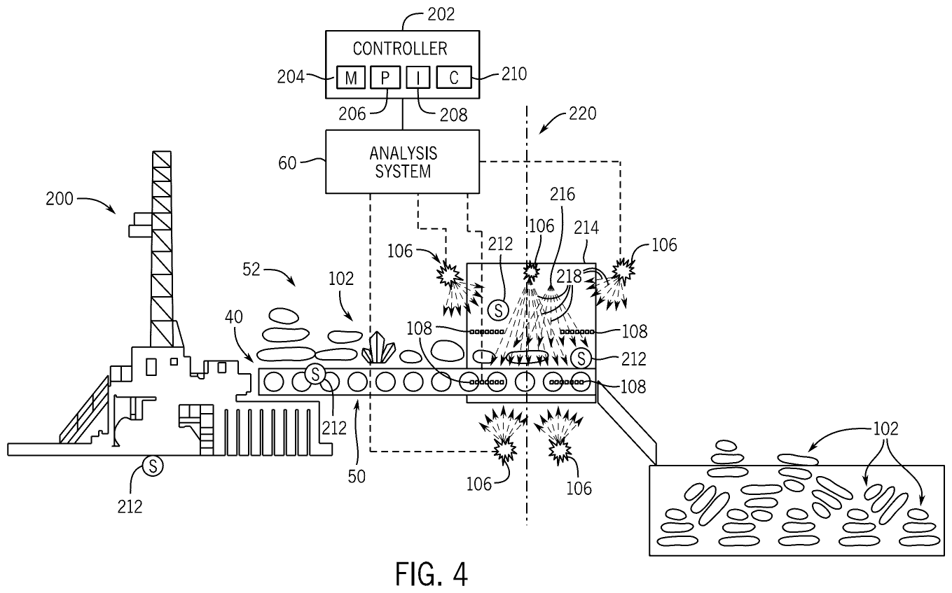

In addition, as illustrated in FIG. 1, in certain embodiments, the analysis system 60 (e.g., a mud logging unit) may be used to control the drilling system 10, as well as provide analysis of the solids 102, as described in greater detail herein. In particular, in certain embodiments, the analysis system 60 may be configured to automatically analyze images of the solids 102 that are automatically captured by the image devices 56 during operation of the drilling system 10. With this in mind, FIG. 4 is a schematic diagram illustrating a drilling system 200 including the tomography system 52. In some embodiments, operations of the drilling system 200, the tomography system 52, the imaging system 54, the analysis system 60, or a combination thereof, may be controlled via a controller 202. The controller 202 includes memory 204, one or more processors 206, instructions 208 stored on the memory 204 and executable by the processor 206, and communication circuitry 210 configured to communicate with sensors, imaging devices 56, and various equipment of the drilling system 200. For example, the controller 202 is configured to receive sensor feedback from one or more sensors 212 coupled to the shale shaker 40, the conveyor 50, the imaging system 54, the analysis system 60, and/or additional components of the drilling system 200 and control the same equipment based on the sensor feedback, operating modes, user input, computer models, or any combination thereof. The sensors 212 may include surface sensors (Internet of Things (IoT) sensors, gauges, and so forth) and/or downhole sensors, or any combination thereof.

As shown in FIG. 4, solids 102 may move along the conveyor 50 through an imaging zone 214. The imaging zone 214 may include components of the tomography system 52 including the imaging system 54. As such, the sources 106 may be controlled by the controller 202 to irradiate the solids 102 with a particular energy level 216 as they move through the imaging zone 214. In certain embodiments, the detectors 108 may be configured to measure transmission signals resulting from the particular energy level 216 interacting with the solids 102. In some embodiments, the sources 106 may irradiate the solids 102 with multiple energy levels 218 (e.g., 2, 3, 4, 5, 6, 7, 8, 9, 10, or more energy levels). Irradiation of the solids 102 with the multiple energy levels 218 may occur at the same time (e.g., concurrently, simultaneously), in a sequence, or in any suitable configuration. As such, the detectors 108 may be positioned to collect transmission signals of the multiple energy levels 218 interacting with the solids 102. That is, as the solids 102 attenuate the multiple energy levels 218 irradiated by the sources 106, the detectors 108 may measure attenuation of transmission. In certain embodiments, transmission tomography of the solids 102 may be achieved using a static imaging configuration. The static imaging configuration may use sources 106 and detectors 108 positioned at different positions and angles to collect various perspectives of the solids 102 as they move along the conveyor 50. In some embodiments, the sources 106 and the detectors 108 may be configured to move during acquisition of the image data. For example, the sources 106 and the detectors 108 may be configured to rotate around the solids 102 (e.g., around a longitudinal axis of the conveyor 50), move along the solids 102 (e.g., upstream or downstream directions along the longitudinal axis of the conveyor 50), move laterally relative to the solids 102 (e.g., crosswise direction relative to the longitudinal axis of the conveyor 50), pivot an angle of transmission between the sources 106 and the detectors 108 relative to a frame of reference (e.g., conveyor 50 and/or longitudinal axis), or any combination thereof.

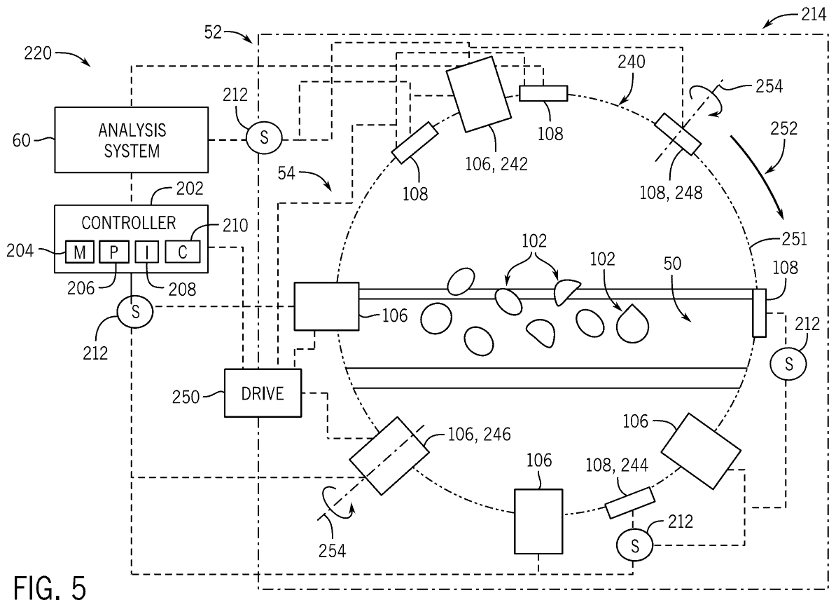

With the foregoing in mind, FIG. 5 is a cross-sectional view 220 of the imaging zone 214 illustrated in FIG. 4. The cross-sectional view 220 of the imaging zone 214 illustrates solids 102 on the conveyor 50. The solids 102 may be in a similar imaging plane 240 along the conveyor 50. In some embodiments, the sources 106 and the detectors 108 may be positioned circumferentially surrounding the solids 102 on the conveyor 50 within the imaging plane 240, such as an annular arrangement of the sources 106 and the detectors 108. In some instances, the sources 106 and the detectors 108 may be in fixed positions or movable positions around the solids 102 on the conveyor 50 within the imaging plane 240. In either case, the sources 106 may irradiate the solids 102 at various angles relative to a reference axis or plane (e.g., a horizontal reference axis or plane, a vertical reference axis or plane, etc.). In certain embodiments, the reference axis or plane may be defined as the top surface of the conveyor 50. The sources 106 and the detectors 108 may be spaced uniformly or non-uniformly around the solids 102 on the conveyor 50 within the imaging plane 240. For example, the sources 106 may be spaced at uniform angles (e.g., 30, 45, 60, or 90 degree angular increments) or variable, non-uniform angles 360 degrees around the solids 102 on the conveyor 50 within the imaging plane 240. Similarly, the detectors 108 may be spaced at uniform angles (e.g., 30, 45, 60, or 90 degree angular increments) or variable, non-uniform angles 360 degrees around the solids 102 on the conveyor 50 within the imaging plane 240. Each of the detectors 108 is configured to detect transmissions from one or more of the sources 106 one or more energy levels. For example, a first source 106, 242 may irradiate the solids 102 (e.g., transmit one or more energy levels through the solids 102) and the one or more transmission signals may be collected by a first detector 108, 244. In certain embodiments, a second source 106, 246 may irradiate the solids 102 and the transmission signals may be collected by a second detector 108, 248. It should be noted, that in some instances, the transmission signals may be collected at an angle relative to irradiation of the solids 102 by the sources 106. As such, the second source 106, 246 may irradiate the solids 102 and the transmission signals may be collected by the first detector 108, 244.

In some embodiments, the sources 106, the detectors 108, or a combination thereof, may be coupled to a drive 250. The drive 250 may include a motor (e.g., electric motor, pneumatic motor, or hydraulic motor) coupled to a transmission (e.g., gear assembly, belt assembly, etc.), which in turn couples to a framework 251 (e.g., annular framework) supporting the sources 106 and the detectors 108. The drive 250 may be controlled by the controller 202 to rotate the sources 106 and/or the detectors 108 supported by the framework 251 around the conveyor 50 (e.g., about a longitudinal axis of the conveyor 50). As such, the sources 106 and the detectors 108 supported by the framework 251 may rotate in a circular motion 252 around the solids 102 located in the imaging plane 240. In this manner, image data may be collected at various angles as the sources 106 and detectors 108 are rotated about the conveyor 50. In some embodiments, the drive 250 may be controlled by the controller 202 to rotate the first source 106, 242 and the first detector 108, 244 in a circular motion around the solids 102. In certain embodiments, the drive 250 may rotate the second source 106, 256 and/or the second detector 108, 248 about an axis of rotation 254. In this manner, the second source 106, 256 and the second detector 108, 248 may be positioned at one or more angles to irradiate and collect transmission signals from the solids 102, respectively.

In certain embodiments, the drive 250 may be configured to move the sources 106 and/or the detectors 108 supported by the framework 251 in an upstream and/or downstream direction along the longitudinal axis of the conveyor 50, in a crosswise direction (e.g., radial direction) relative to the longitudinal axis of the conveyor 50, in a rotational direction about the longitudinal axis of the conveyor 50 as discussed above, in a tilt angle of a plane of the framework 251 relative to the longitudinal axis of the conveyor 50, or any combination thereof. For example, the tilt angle may be 90 degrees to position all of the sources 106 and the detectors 108 at a common axial position along the longitudinal axis of the conveyor 50, or the tilt angle may be an acute angle (e.g., 10, 15, 20, 30, 45, 60, or 75 degrees) to position the sources 106 and the detectors upstream and downstream relative to one another along the longitudinal axis of the conveyor 50. In certain embodiments, the imaging system 54 of the tomography system 52 may include a plurality of sets of the sources 106 and the detectors 108 disposed on separate frameworks 251, wherein each of the frameworks 251 supporting the sources 106 and the detectors 108 may be movable by a respective drive 250 or in a fixed position. For example, the controller 202 may be configured to control the drives 250 to move the different frameworks 251 supporting the sources 106 and the detectors 108 in opposite rotational directions, in different angles, and/or in different positions to help increase coverage for imaging the solids 102. In some embodiments, the different frameworks 251 supporting the sources 106 and the detectors 108 may be in different fixed positions, wherein the different fixed positions help increase coverage for imaging the solids 102. In some embodiments, one or more of the different frameworks 251 supporting the sources 106 and the detectors 108 may be in one or more fixed positions, whereas one or more of the different frameworks 251 supporting the sources 106 and the detectors 108 may be moveable by the respective drives 250 as discussed above. In some embodiments, the frameworks 251 supporting the sources 106 and the detectors 108, the sources 106 and/or the detectors 108 independently, or a combination thereof, may be configured to move in response to movement of the solids 102, movement of the conveyor 50, geometries of the solids 102, or any combination thereof, to help improve imaging from a plurality of perspectives about the solids 102. It should be noted, that additional configurations are envisioned and one or more additional sources 106 and/or additional detectors 108 may be controlled by the drive 250 to move about the imaging plane 240 during acquisition of tomographic data.

In some embodiments, the imaging system 54 may send transmission signals (e.g., image data, tomographic data) to the analysis system 60. In some embodiments, the analysis system 60 may analyze, track, reconstruct, and provide lithographic information to the tomography system 52 to control operations of the drilling system 200. For example, the image data may include one or more frames corresponding to one or more points in time in which the solids 102 are imaged moving along the conveyor 50. That is, the solids 102 may be imaged simultaneously in near real-time as the solids 102 are extracted from the reservoir. As shown, solids 102 of different shapes, sizes, composition, and the like may be extracted from the reservoir. The solids 102 may move along the conveyor 50 of the shale shaker 40 through the imaging zone 214 of the tomography system 52. The image data may be analyzed by the analysis system 60 to provide structural characteristics of each solid of the solids 102 moving along the conveyor 50.

In some embodiments, the structural characteristics may include porosity, saturation, permeability, and the like of the solids 102. The structural characteristics may be extracted from the image data using computerized tomography methods, numerical simulations, machine learning algorithms, one or more additional methods, or a combination thereof. The structural characteristics extracted from the image data may be used to infer information about petrophysical properties of the solids 102 and/or the reservoir. High throughput of image analysis of the solids 102 during extraction from the reservoir may provide geomechanical insight to the reservoir to inform drilling operations, such as well constructions and well integrity analysis, and to enable near real-time control of the drilling system 10 in response to the near real-time analysis of the solids 102 via the tomography system 52.

In certain embodiments, due to movement of the solids 102 during acquisition of image data, a tracking model may be used to correlate motion parameters of a particular solid with attenuation properties and geometric properties of the particular solid. As such, the tracking model may be used to determine a location of the particular solid moving on the conveyor 50. The location of the particular solid may be used during reconstruction of the image data and/or generation of structural characteristics of the particular solid. The tracking model may determine a speed of motion of the solids 102 on the conveyor 50. The speed of motion may be based on an externally controlled speed of the conveyor 50. In some instances, the externally controlled speed of the conveyor may be input to the tracking model. In some embodiments, the tracking model may analyze the image data and extract one or more directional transmission attenuation scans. The directional transmission attenuation scans may be analyzed by modeling the solids 102 as Gaussians. In some embodiments, one or more Gaussians may be used to model the solids 102 and/or perform image reconstruction. As such, the solids 102 are approximated as an isotropic Gaussian that is affinely transformed with a known location, one or more unknown parameters, or a combination thereof. It should be noted, that in some embodiments, generalization may extend the isotropic Gaussian to a Gaussian mixture model where the Gaussian mixture model is affinely transformed.

In some instances, the directional transmission attenuation scans may be further analyzed to remove attenuation effects introduced by noise (e.g., electronic noise, quantum noise, shot noise). Attenuation effects may be removed via attenuation correction factors. Further, in certain embodiments, modeling of the directional transmission attenuation scans may be optimized for one or more additional parameters. For example, in certain embodiments, the solids 102 may move in one or more additional directions (e.g., in addition to motion of the conveyor 50). As such, the tracking model may consider additional kinematic information to determine the location of solids 102 moving through the image zone 214 during acquisition of the image data. Prediction optimization may include modeling rotational motion, vertical motion, and one or more additional directions of motion of the solids 102 during image data acquisition. As such, Gaussians may be constructed to model the kinematics of the solids (e.g., directional motion) through computation of hypothetical projections and optimization of trajectory estimation of Gaussians may be conducted for a loss function. Further, residual improvement of the tracking model may be applied via minimizing residual errors with a loss function. In this manner, the tracking model may determine the location of particular solids and provide reconstructed images for use in assigning structural characteristics of the solids 102 extracted from the reservoir.

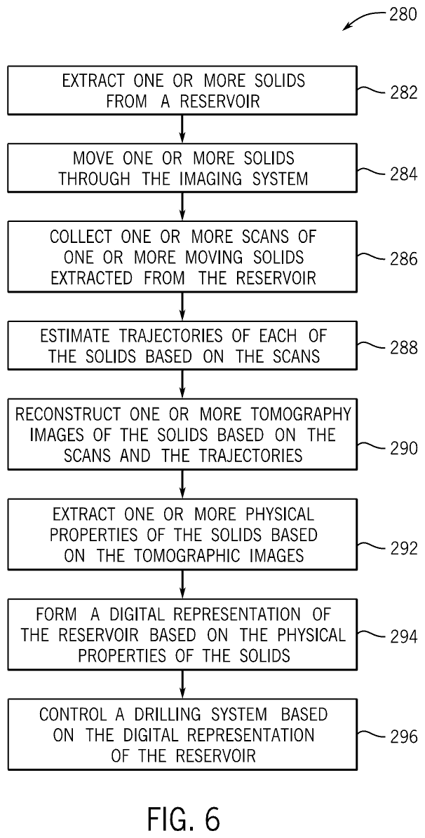

Referring now to FIG. 6, the tomography system 52 may perform a process 280 for extracting one or more physical properties from image data of solids extracted from a reservoir. The process 280 may be performed by a computing device or controller disclosed above with reference to FIG. 1 and/or FIG. 4, or any other suitable computing device(s) or controller(s). Furthermore, the blocks of the process 280 may be performed in the order disclosed herein or in any suitable order. For example, certain blocks of the process may be performed concurrently. In addition, in certain embodiments, at least one of the blocks of the process 280 may be omitted.

At block 282 of the process 280, the tomography system 52 may extract the one or more solids 102 from a reservoir. The solids 102 may be extracted at a depth of the driller floor 20 and may be received from the drilling system 10. The shale shaker 40 may separate the solids 102 from the drilling mud via a sieve to obtain the solids 102. The solids 102 may be delivered (e.g., via the conveyor 50) to the imaging system 54. At block 284 of the process 280, the tomography system 52 may move the solids 102 through the imaging system 54. In some embodiments, the solids 102 may move through the imaging zone 214, the imaging plane 240, or a combination thereof. A speed of the conveyor 50 may be controlled by the controller 202 to move the solids 102 through the imaging system 54 to provide continuous high-throughput of data acquisition of the solids 102. As such, the conveyor 50 may operate at a speed to optimize image reconstruction and drilling operations. In certain embodiments, the speed of the conveyor 50 may be varied to move the solids 102 through the imaging system 54 at varied speeds based on the operation conditions of the drilling system 10 and/or depending on the volume and/or complexity of the solids 102. For example, the controller 202 may increase a speed of the conveyor 50 corresponding to decreases in the size, number, and/or complexity of the solids 102 along the conveyor 50, the controller 202 may decrease a speed of the conveyor 50 corresponding to increases in the size, number, and/or complexity of the solids 102 along the conveyor 50, or any combination thereof.

At block 286 of the process 280, the tomography system 52 may collect one or more scans (e.g., directional transmission attenuation scans) of the one or more solids moving extracted from the reservoir. The imaging system 54 may take one or more transmission images of the solids 102 by using the controller 202 to control the imaging devices 56 (e.g., sources 106, detectors 108). In some embodiments, the transmission images may include attenuation signals based on an interaction of the sources 106 with the solids 102. The sources 106 may continuously irradiate the solids 102 moving through the imaging system 54 with X-rays, gamma rays, neutrons, or one or more additional energy sources. Attenuation signals may be based on interaction of one or more energy levels with the solids 102. The transmission images collected based on a single energy level attenuation of the solid 102 may include two-dimensional data (e.g., spatial data, intensity data) for image reconstruction. In certain embodiments, the transmission images collected based on interaction of multiple energy levels with the solids 102. As such, the transmission images may include three-dimensional data (e.g., spatial data, intensity data, spectral data) for image reconstruction. The spectral data may enable further characterization of the structural properties of the solids 102, such as mineral characterization. The analysis system 60 may receive the transmission image of the solids 102 from the imaging system 54. In some embodiments, the tomography system 52 may collect one or more calibration scans and/or perform calibration processes. The calibration scans may include background images (e.g., images without solids 102), darkfield images (e.g., images with the sources 106 turned off), and the like to account for environmental noise, imaging device response, imaging device orientation, and the like.

At block 288 of the process 280, the tomography system 52 may estimate trajectories of each of the solids based on the scans. Estimation of the trajectories of the solids 102 may provide time-resolution for reconstruction of the transmission images to provide structural properties of the solids 102 during extraction from the reservoir. The trajectories may include one or more vectors of directional motion. The vectors of directional motion may include motion of the solids 102 along the conveyor 50. The motion of the solids 102 along the conveyor 50 may be externally controlled and may be provided as an input to the analysis system 60. As such, the analysis system 60 may model the scans using a Gaussian model, a mixed Gaussian model, or other suitable models to track movement of the solids 102 during transmission image acquisition. For example, the Gaussian model may approximate trajectories of the solids 102 using one or more isotropic Gaussians. It should be noted that in some embodiments, the analysis system 60 of the tomography system 52 may perform one or more preprocessing steps prior to and/or after trajectories of the solids 102 are extracted from the transmission images. The preprocessing steps may include establishing a linear relationship between the transmission images and reconstruction based on an intensity of the source 106, attenuation of the source 106 (e.g., decay of transmission through the solids 102), background correction based on the calibration scans, and the like.

At block 290 of the process 280, the tomography system 52 may reconstruct one or more tomographic images of the solids based on the scans and the trajectories. Reconstruction of the tomographic images may include inferring one or more structural properties of the solids 102 based on transmission images taken at one or more angles, one or more energy levels, or a combination thereof by the detectors 108. In some embodiments, the analysis system 60 of the tomography system 52 may perform reconstruction of the transmission images via generative models, algebraic techniques, filtered-backprojection, simultaneous iterative reconstruction technique, and the like. As such, reconstruction of the tomographic images may provide an estimate of structural properties of the solids 102 based on projections of the solids 102 during attenuation of the source 106 capture by the transmission images.

At block 292 of the process 280, the tomography system 52 may extract one or more physical properties of the solids based on the tomographic images. The physical properties may include a porosity, a saturation (e.g., water saturation), a permeability, mineralogy, lithology, density, and the like of the solids 102 extracted from the reservoir. The physical properties of the solids 102 may be used to predict characteristics and parameters for the geologic formation, which may be further used to control the drilling system 10 in near real-time. At block 294 of the process 280, the tomography system 52 may form a digital representation of the reservoir based on the physical properties of the solids 102. The digital representation may include a detailed record, a master log file, and the like for the reservoir (e.g., geologic formation). The digital representation may include information regarding the geologic properties (e.g., lithology, layer, depositional environments) and petrophysical characterization (e.g., water saturation, porosity, permeability, volume of shale) of the reservoir, which may be used to control the drilling system 10 or a drilling plan of the drilling system 10. At block 296 of the process 280, the tomography system 52 may control a drilling system 10 based on the digital representation of the reservoir. To obtain accurate results, a large amount of transmission images of the solids 102 may be analyzed to provide near real-time analysis of properties of the reservoir. As such, the drilling system 10 may be controlled based on continuous generation of digital representations of the reservoir during drilling operations.

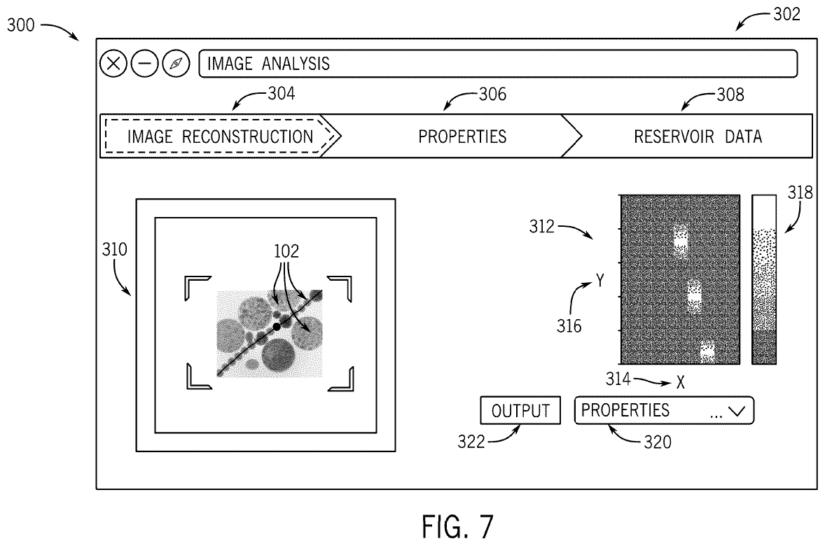

FIG. 7 is an illustrative embodiment of a user interface 300 of an electronic display of the tomography system 52. The user interface 300 may display a screen having a dashboard 302 (e.g., command center) that may be used to visualize the tomographic images before and/or after image reconstruction. In this manner, the tomography system 52 provides centralized feedback to the users via the dashboard 302. The dashboard 302 may include various widgets (e.g., user interface widgets) providing alerts, notifications, status updates, image reconstructions, structural data, and the like.

In some embodiments, the various widgets of the dashboard 302 include an image reconstruction widget 304, a properties widget 306, a reservoir data widget 308, one or more additional widgets, or a combination thereof. As shown, the image reconstruction widget 304 may be selected to display a reconstructed image 310. The reconstructed image 310 may provide structural information of the solids 102 imaged by the tomography system 52. The reconstructed image 310 may provide information about the structural properties of the solids 102, such as the porosity, the saturation, the permeability, and the like. The image reconstruction widget 304 may also include a heat map 312 of a Gaussian recovered from a transmission image acquired by the imaging system 54. The heat map 312 may illustrate tracking of a particular solid over in space (e.g., x-axis 314, y-axis 316). An intensity 318 of the Gaussian may correspond to a strength in attenuation by the solids 102. In some embodiments, the heat map 312 may include time-resolved information based on trajectories of the solids 102 in time as they move through the imaging system 54.

In certain embodiments, one or more properties (e.g., structural properties) may be extracted from the reconstructed image 310, the heat map 312, or a combination thereof. In some instances, a user may select an output 322 corresponding to the properties 320. In this manner, the dashboard 302 may open a screen of the properties widget 306, the reservoir data widget 308, or additional widgets to provide additional information related to the solids 102 measured by the tomography system 52. For example, a digital representation of the reservoir may be presented by the reservoir data widget 308. The digital representation of the reservoir may be used to control the drilling operation via the drilling system 10, such as control to change an angle or direction of drilling (e.g., via the RSS), stop drilling operations, change a rotational speed of a drill bit, change a flow rate and pressure of drilling mud, additional properties, and the like. Characteristics of the solids 102 may be utilized to provide subsurface characterization to geoscientists and reservoir engineers in the oil and gas industry in near real-time. As a result, an efficiency of the drilling operation may be increased based on information extracted from the solids 102 produced during reservoir drilling by the drilling system 10.

Technical effects of the disclosed embodiments include a tomography system 52 for extracting physical properties of solids from transmission images taken in the context of oil and/or gas exploration. The tomography system 52 may include an imaging system 54 and an analysis system 60. The imaging system 54 may include one or more sources 106, one or more detectors 108, or a combination thereof controlled by a controller 202 to acquire transmission images of one or more solids 102 moving on a conveyor 50 of a shale shaker 40 after extraction from a reservoir. The transmission images may be reconstructed to provide physical properties of the solids 102. The tomography system 52 may help streamline subsurface analysis through analysis of the solids 102 extracted during drilling. By streamlining solids analysis through incorporation of the tomography system 52 overall performance and efficiency of the drilling system is improved through near real-time analysis of reservoir characteristics. The disclosed techniques result may result in reduced down time during drilling operations with less time spent analyzing solids off-site. Further, deployment of the presently disclosed techniques may provide improved efficiency and performance of drilling operations.

The subject matter described in detail above may be defined by one or more clauses, as set forth below.

A system is provided that includes one or more sources used to irradiate one or more solids extracted from a reservoir with an energy source and one or more detectors used to acquire one or more transmission images, wherein the one or more transmission images comprise one or more scans. The system also includes a processing circuitry and a memory, accessible by the processing circuitry, the memory storing instructions that, when executed by the processing circuitry cause the processing circuitry to perform operations. The operations may include collecting one or more scans of the one or more solids moving through an imaging zone, reconstructing one or more tomographic images of the one or more solids based on the one or more scans, and extracting one or more physical properties of the solids based on the one or more tomographic images.

The system of the preceding clause, wherein the energy source comprises an X-ray source, neutron source, or a gamma ray source.

The system of any of the preceding clauses, the processing circuitry performs the operations including forming a digital representation of the reservoir based on the one or more physical properties of the one or more solids and controlling a drilling system based on the digital representation of the reservoir.

The system of any of the preceding clauses, wherein the processing circuitry performs the operations including controlling movement of the one or more solids through the imaging zone, wherein the imaging zone comprises the one or more sources and the one or more detectors.

The system of any of the preceding clauses, wherein the one or more scans comprise one or more directional transmission attenuation scans.

The system of any of the preceding clauses, wherein the one or more physical properties comprise a porosity, a saturation, a permeability, a mineralogy, a lithology, a density, or a combination thereof.

The system of any of the preceding clauses, wherein the processing circuitry performs the operations including estimating one or more trajectories of the one or more solids based on the one or more scans.

The system of any of the preceding clauses, wherein reconstructing the one or more tomographic images comprises modeling the one or more trajectories as one or more isotropic Gaussians.

The system of any of the preceding clauses, wherein the one or more sources and the one or more detectors are in a fixed position.

The system of any of the preceding clauses, wherein the one or more sources and the one or more detectors rotate about a conveyor moving the one or more solids through an imaging zone.

A method includes extracting one or more solids from a reservoir, moving the one or more solids through an imaging zone, wherein the imaging zone comprises one or more sources and one or more detectors, collecting one or more scans of the one or more solids moving through the imaging zone, and reconstructing one or more tomographic images of the one or more solids based on the one or more scans; and extracting one or more physical properties of the solids based on the one or more tomographic images.

The method of the preceding clause, including estimating one or more trajectories of the one or more solids based on the one or more scans.

The method of any of the preceding clauses, including forming a digital representation of the reservoir based on the one or more physical properties of the one or more solids.

The method of any of the preceding clauses, including controlling a drilling system based on the digital representation of the reservoir.

The method of any of the preceding clauses, wherein the one or more scans comprise one or more directional transmission attenuation scans.

The method of any of the preceding clauses, wherein the one or more physical properties comprise a porosity, a saturation, a permeability, a mineralogy, a lithology, a density, or a combination thereof.

The method of any of the preceding clauses, wherein the one or more sources and the one or more detectors rotate about the one or more solids moving through the imaging zone.

A non-transitory, computer-readable storage medium, comprising processor-executable routines that, when executed by a processor, cause the processor to perform operations including extracting one or more solids from a reservoir, moving the one or more solids through an imaging zone, wherein the imaging zone comprises one or more sources and one or more detectors, collecting one or more scans of the one or more solids moving through the imaging zone, and reconstructing one or more tomographic images of the one or more solids based on the one or more scans; and extracting one or more physical properties of the solids based on the one or more tomographic images. The operations also include forming a digital representation of the reservoir based on the one or more physical properties of the one or more solids and controlling a drilling system based on the digital representation of the reservoir.

The non-transitory computer-readable storage medium of the preceding clause, wherein the processor performs operations includes estimating one or more trajectories of the one or more solids based on the one or more scans.

The non-transitory computer-readable storage medium of any of the preceding clauses, wherein the one or more physical properties comprise a porosity, a saturation, a permeability, a mineralogy, a lithology, a density, or a combination thereof.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more sources configured to irradiate one or more solids extracted from a reservoir with an energy source;
one or more detectors configured to acquire one or more transmission images, wherein the one or more transmission images comprise one or more scans;
a processing circuitry; and
a memory, accessible by the processing circuitry, the memory storing instructions that, when executed by the processing circuitry cause the processing circuitry to perform operations comprising:
collecting one or more scans of the one or more solids moving through an imaging zone;
reconstructing one or more tomographic images of the one or more solids based on the one or more scans; and
extracting one or more physical properties of the solids based on the one or more tomographic images.

2. The system of claim 1, wherein the energy source comprises an X-ray source, neutron source or a gamma ray source.

3. The system of claim 2, wherein the processing circuitry performs the operations comprising:
forming a digital representation of the reservoir based on the one or more physical properties of the one or more solids; and
controlling a drilling system based on the digital representation of the reservoir.

4. The system of claim 1, wherein the processing circuitry performs the operations comprising:
controlling movement of the one or more solids through the imaging zone, wherein the imaging zone comprises the one or more sources and the one or more detectors.

5. The system of claim 1, wherein the one or more scans comprise one or more directional transmission attenuation scans.

6. The system of claim 1, wherein the one or more physical properties comprise a porosity, a saturation, a permeability, a mineralogy, a lithology, a density, or a combination thereof.

7. The system of claim 1, wherein the processing circuitry performs the operations comprising:
estimating one or more trajectories of the one or more solids based on the one or more scans.

8. The system of claim 7, wherein reconstructing the one or more tomographic images comprises modeling the one or more trajectories as one or more affinely transform isotropic Gaussians.

9. The system of claim 1, wherein the one or more sources and the one or more detectors are in a fixed position.

10. The system of claim 1, wherein the one or more sources and the one or more detectors rotate about a conveyor moving the one or more solids through an imaging zone.

11. A method comprising:
extracting one or more solids from a reservoir;
moving the one or more solids through an imaging zone, wherein the imaging zone comprises one or more sources and one or more detectors;
collecting one or more scans of the one or more solids moving through the imaging zone;
reconstructing one or more tomographic images of the one or more solids based on the one or more scans; and
extracting one or more physical properties of the solids based on the one or more tomographic images.

12. The method of claim 11 comprising:
estimating one or more trajectories of the one or more solids based on the one or more scans.

13. The method of claim 11, comprising:
forming a digital representation of the reservoir based on the one or more physical properties of the one or more solids.

14. The method of claim 13, comprising:
controlling a drilling system based on the digital representation of the reservoir.

15. The method of claim 11, wherein the one or more scans comprise one or more directional transmission attenuation scans.

16. The method of claim 11, wherein the one or more physical properties comprise a porosity, a saturation, a permeability, a mineralogy, a lithology, a density, or a combination thereof.

17. The method of claim 11, wherein the one or more sources and the one or more detectors rotate about the one or more solids moving through the imaging zone.

18. A non-transitory, computer-readable storage medium, comprising processor-executable routines that, when executed by a processor, cause the processor to perform operations comprising:
extracting one or more solids from a reservoir;
moving the one or more solids through an imaging zone, wherein the imaging zone comprises one or more sources and one or more detectors;
collecting one or more scans of the solids moving through the imaging zone;
reconstructing one or more tomographic images of the one or more solids based on the one or more scans;
extracting one or more physical properties of the solids based on the one or more tomographic images;
forming a digital representation of the reservoir based on the one or more physical properties of the one or more solids; and
controlling a drilling system based on the digital representation of the reservoir.

19. The non-transitory computer-readable storage medium of claim 18, wherein the processor performs operations comprising:
estimating one or more trajectories of the one or more solids based on the one or more scans.

20. The non-transitory computer-readable storage medium of claim 18, wherein the one or more physical properties comprise a porosity, a saturation, a permeability, a mineralogy, a lithology, a density, or a combination thereof.
